(19) United States
(12) Patent Application Publication
(10) Pub. No.: US 2021/0261285 A1
(43) Pub. Date: Aug. 26, 2021

(54) STACKABLE SHELF TRAY

(71) Applicant: Sonoco Development, Inc., Hartsville, SC (US)

(72) Inventor: Glen Bersamin, New Lenox, IL (US)

(73) Assignee: Sonoco Development, Inc., Hartsville, SC (US)

(21) Appl. No.: 16/795,839

(22) Filed: Feb. 20, 2020

(51) Int. Cl. B65D 5/30; B65D 5/00; B65D 5/42; B65D 5/44; B31D 5/00

(52) U.S. Cl. CPC B65D 5/308; B65D 5/0045; B31D 5/00; B65D 5/443; B65D 5/4204

(57) ABSTRACT

A shelf tray for shipping and displaying palletized products is provided. The shelf tray is made from a single folded blank and includes horizontal top ledges to support trays mounted on top without caving.

### BACKGROUND OF THE INVENTION

### Field of the Invention

This patent relates to a shelf tray for use in shipping and displaying products. More particularly, this patent relates to a unique shelf tray for use as a component of a pallet display, the shelf tray including horizontal “ledge” panels to support trays mounted on top and to prevent caving.

### Description of the Related Art

Pallet displays are display structures that can be used to ship products on a pallet and then display the products in a retail setting. Pallet displays having multiple shelves for supporting products are well known. Some pallet displays are made of multiple corrugated components and sometimes even require fasteners. Pallet displays can require complex assembly steps, and can be large even when knocked down. The shelves of the pallet displays can sag under the weight of the products. The present disclosure addresses these problems.

### BRIEF SUMMARY OF THE INVENTION

The present disclosure relates to a shelf tray for use in a packaging system for shipping and displaying palletized products. The shelf tray is made from a single folded blank, and includes horizontally oriented top ledges that can support additional shelf trays mounted on top without caving.

In a first aspect of the disclosure a shelf tray is provided comprising a load bearing surface, two ends, two sides and a top. The shelf tray is made from a single folded blank, and is configured to support one or more shelf trays stacked on top. The load bearing surface supports one or more products, and comprises a bottom panel having a substantially rectangular periphery comprising two opposing end fold lines and two opposing side fold lines. Each end comprises a horizontally elongated outer end panel and two outer facing panels. Each outer facing panel is foldably connected to an inner facing panel along a wing fold line. The outer end panel extends upward from the bottom panel and terminates in a first fold line. Each of the outer facing panels extends toward each other from respective corner fold lines and terminates in a free edge. The outer end panel and the outer facing panels define an end opening through which the one or more products may be accessed. Each of the two sides comprises a U-shaped side panel extends upward from the bottom panel to a top fold line and laterally from one corner fold line to another corner fold line. The top comprises two top ledges, each of the top ledges being hingedly attached to a corresponding U-shaped side panel along the top fold line and supported at either end by an outer facing panel. The top ledges extend toward each other from respective top fold lines.

The shelf tray may further comprise a top flap hingedly attached to each outer facing panel along a top flap fold line, and a locking tab foldably attached to each end of the top ledge. Each locking tab extends through a slot located collinear with or adjacent to one of the top flap fold lines and into a notch defined by one of the inner facing panels. Each notch may have a top edge that is in contact with and supports a locking tab.

In another aspect of the disclosure a blank for making shelf tray is provided. The blank comprises a bottom panel, two side wall assemblies, four end wing assemblies, two end panel assemblies and two top assemblies. The bottom panel has a rectangular perimeter defined by parallel, opposing side fold lines and parallel, opposing end fold lines. Each side wall assembly is hingedly attached to the bottom panel along a side fold line. Each side wall assembly comprises a U-shaped side panel and an inner facing side panel. The U-shaped side panel may comprise a horizontal base panel and two leg panels extending from opposite ends of the horizontal base panel to form a ‘U’ shape. The inner facing side panel is hingedly attached to the horizontal base panel along a second fold line. Each end wing assembly comprises an outer facing panel hingedly attached to one of the leg panels along a corner fold line, an inner facing panel hingedly attached to the outer facing panel along a wing fold line, and a top flap hingedly attached to the outer facing panel along a top flap fold line. Each end wing assembly defines a slot collinear with or adjacent to the top flap fold line. Each inner facing panel defines a notch located along and in communication with a top edge of the inner facing panel. Each end panel assembly comprises an outer end panel hingedly attached to the bottom panel along one of the end fold lines and an inner end panel hingedly attached to the outer end panel along a first fold line. Each top assembly comprises a top ledge having two ends and two locking tabs. Each locking tab is foldably attached to an end. The top ledge is hingedly attached to two leg panels that form one of the U-shaped side panels along a top fold line.

The blank is foldable into a three-dimensional shelf tray wherein the top ledges form a top upon which a second shelf tray may be supported, each top ledge is supported at either end by one of the outer facing panels, and each locking tab extends through one of the slots and into one of the notches.

### BRIEF DESCRIPTION OF THE DRAWINGS

FIG. 1 is a perspective view of a shelf tray according to the disclosure.

FIG. 2 is a top view of a blank used to make the shelf tray of FIG. 1.

FIGS. 3-9 are perspective views of the shelf tray of FIG. 1 shown in various stages of assembly.

FIG. 3 is a perspective view of the blank of FIG. 2.

FIG. 4 is a perspective view of the blank of FIG. 3 shown partially folded to create a partially assembled shelf tray.

FIG. 5 is a perspective view of the partially assembled shelf tray of FIG. 4 after further folding.

FIG. 6 is a perspective view of the partially assembled shelf tray of FIG. 5 after further folding.

FIG. 7 is a perspective view of the partially assembled shelf tray of FIG. 6 after further folding.

FIG. 8 is a perspective view of the partially assembled shelf tray of FIG. 7 after further folding.

FIG. 9 is a perspective view of a packaging system comprising multiple assembled shelf trays with certain structural features removed for clarity.

### DETAILED DESCRIPTION OF THE INVENTION

While the invention described herein may be embodied in many forms, there is shown in the drawings and will herein be described in detail one or more embodiments with the understanding that this disclosure is to be considered an exemplification of the principles of the invention and is not intended to limit the disclosure to the illustrated embodiments. Aspects of the different embodiments can be combined with or substituted for one another.

As will be appreciated, terms such as “above” and “below”, “upper” and “lower”, “top” and “bottom,” “front” and “back,” (etc.), used as nouns, adjectives or adverbs refer in this description to the orientation of the structure as it is illustrated in the various views. Such terms are not intended to limit the invention to a particular orientation.

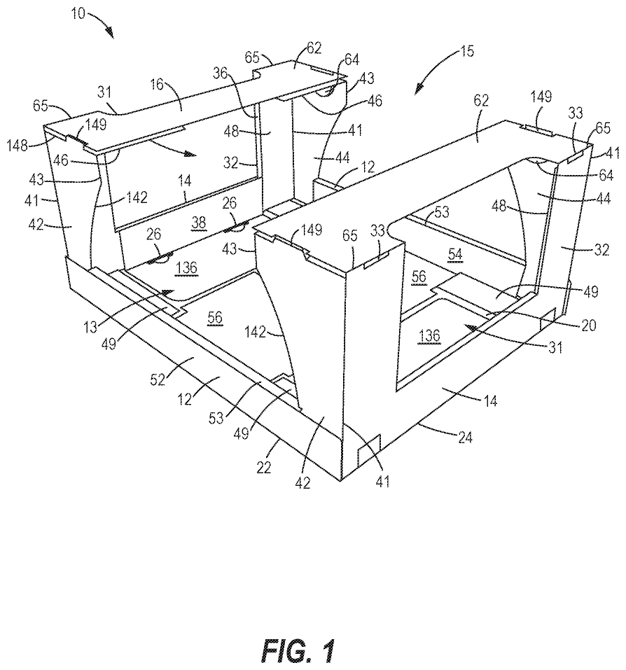

FIG. 1 is a perspective view of a shelf tray 10 according to the disclosure. The shelf tray 10 comprises a load bearing bottom panel 20, two ends 12 that may serve as the front and rear, two sides 14 and a top 16. The shelf tray 10 may be “four side shoppable”, meaning it may have openings on both ends 12 and both sides 14 for easy access to the products (not shown in the figures). The finished shelf tray 10 may be stacked on top of and secured to a second shelf tray 10 by tabs and slots or other attachment means as explained below.

The bottom panel 20 has a substantially rectangular periphery comprising two 2 0 opposing end edges or end fold lines 22 and two opposing side edges or side fold lines 24. The bottom panel 20 may define side bottom slots 26 and end bottom slots 28 (obscured in FIG. 1) located around its perimeter adjacent to each peripheral edge.

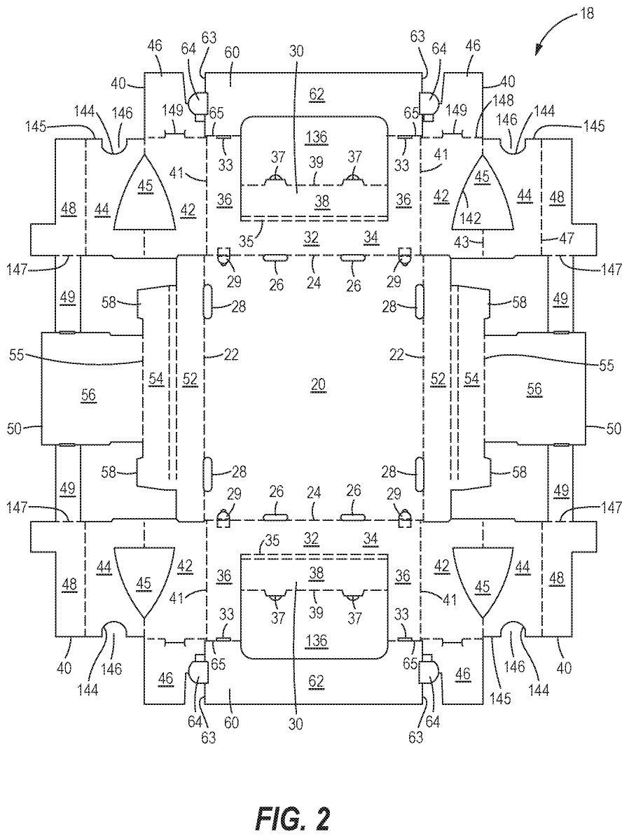

Each (front and rear) end 12 comprises a horizontally elongated outer end panel 52 and two outer facing panels 42. The outer end panel 52 extends upward from the bottom panel 20 and terminates in a double fold line 53. The outer facing panels 42 extend inwardly toward each other from respective corner fold lines 41. Each outer facing panel 42 terminates in a free edge 142 and a wing fold line 43 (see FIG. 2). The outer end panel 52 and the outer facing panels 42 define an end opening 13 for easy access to the products.

Each side 14 comprises a U-shaped side panel 32 extending upward from the bottom panel 20 to a top fold line 65 and laterally from one corner fold line 41 to another corner fold line 41.

The top 16 of the shelf tray 10 comprises two top ledges 62. Each top ledge 62 may be hingedly attached to a corresponding U-shaped side panel 32 along two top fold lines 65. The top ledge 62 may be substantially rectangular, or it may be substantially U-shaped with short legs and an elongated base as shown in FIG. 1. The top ledge 62 and its respective U-shaped side panel 32 define a side window 31.

In a preferred embodiment, the shelf tray 10 does not comprise any glue or other adhesive, and does not require any glue or other adhesive during assembly. The shelf tray 10 is made from a single blank 18, which will now be described.

Shelf Tray Blank

FIG. 2 is a top view of a blank 18 used to make each shelf tray 10 of FIG. 1. The blank 18 may be made from any suitable material, but corrugated board is preferred for its combination of strength, light weight and recyclability. The blank 18 is shown cut and scored from a single piece of material to the desired shape.

The blank 18 comprises a bottom panel 20, two opposing side wall assemblies 30, four end wing assemblies 40, two opposing end panel assemblies 50 and two top assemblies 60.

The bottom panel 20 has a rectangular perimeter defined by parallel, opposing side fold lines 24 and parallel, opposing end fold lines 22. The bottom panel 20 may define two or more side bottom slots 26 adjacent each side fold line 24 and two or more end bottom slots 28 adjacent the end fold lines 22. The shelf tray 10 may further comprise bottom tabs 29 adjacent the side fold lines 24 and/or the end fold lines 22. FIG. 2 depicts bottom tabs 29 adjacent the side fold lines 24 only.

Each side wall assembly 30 extends outwardly from a side fold line 24 and thus is hingedly attached to the bottom panel 20 along a side fold line 24. Each side wall assembly 30 may comprise a U-shaped side panel 32, an inner facing side panel 38 and a second bottom reinforcement panel 136. The U-shaped side panel 32 comprises a horizontal base panel 34 and two leg panels 36 extending outwardly from opposite ends of the horizontal base panel 34. The inner facing side panel 38 is hingedly attached to the horizontal base panel 34 along a fold line 35. Side tabs 37 extend from a fold line 39 of the inner facing side panel 38. The U-shaped side panel 32 may define top slots 33 adjacent a top fold line 65. The second bottom reinforcement panel 136 is rotatably connected to the inner facing side panel 38 along fold line fold line 39.

Each end wing assembly 40 is hingedly attached to a leg panel 36 along a corner fold line 41. Each end wing assembly 40 comprises an outer facing panel 42, an inner facing panel 44, a top flap 46, a side flap 48 and a wing tab 49. The outer facing panel 42 is hingedly attached to a leg panel 36 along the corner fold line 41. The inner facing panel 44 is hingedly attached to the outer facing panel 42 along a wing fold line 43. The inner facing panel 44 may be a mirror image of the outer facing panel 42. Together, the inner facing panel 44 and the outer facing panel 42 define an opening 45 in the blank 18. The side flap 48 is hingedly attached to the inner facing panel 44 along a fold line 47. The wing tab 49 is hingedly attached to the side flap 48 along a fold line 147. The top flap 46 is hingedly attached to the outer facing panel 42 along a top flap fold line 148. Each end wing assembly 40 may define a slot 149 for receiving a respective locking tab 64. The slot 149 may be collinear with or adjacent to a top flap fold line 148. Each inner facing panel 44 may define a notch 146 located along and in communication with a top edge 145 of the inner facing panel 44 to accommodate a locking tab 64. The notch 146 has an inner edge 144 and may be configured to receive the locking tab 64 such that the inner edge 144 of the notch 146 mates with (is in contact with) and supports the locking tab 64 and, in turn, the top ledge 62.

Each of the end panel assemblies 50 is hingedly attached to the bottom panel 20 along an end fold line 22. Each end panel assembly 50 comprises an outer end panel 52, an inner end panel 54 and a first bottom reinforcement panel 56. The outer end panel 52 is hingedly attached to the bottom panel 20 along the end fold line 22. The inner end panel 54 is hingedly attached to the outer end panel 52 along a double fold line 53. The first bottom reinforcement panel 56 is hingedly attached to the inner end panel 54 along a fold line 55. End tabs 58 extend outwardly from the inner end panel 54 along an edge of the inner end panel 54 co-linear with the fold line 55.

Each top assembly 60 may comprise a top ledge 62 having two top ledge ends 63 and locking tabs 64. Each locking tab 64 is foldably attached to a top ledge end 63 of the top ledge 62. The top ledge 62 may be hingedly attached to a corresponding U-shaped side panel 32 and, more specifically, to the leg panels 36 of a corresponding U-shaped side panel 32 along the top fold lines 65. The top ledge 62 may be substantially rectangular, or it may be substantially U-shaped with short legs and an elongated base. In the assembled shelf tray 10 of FIG. 1, the U-shaped side panel 32 and the top ledge 62 define a side window 31.

Shelf Tray Assembly

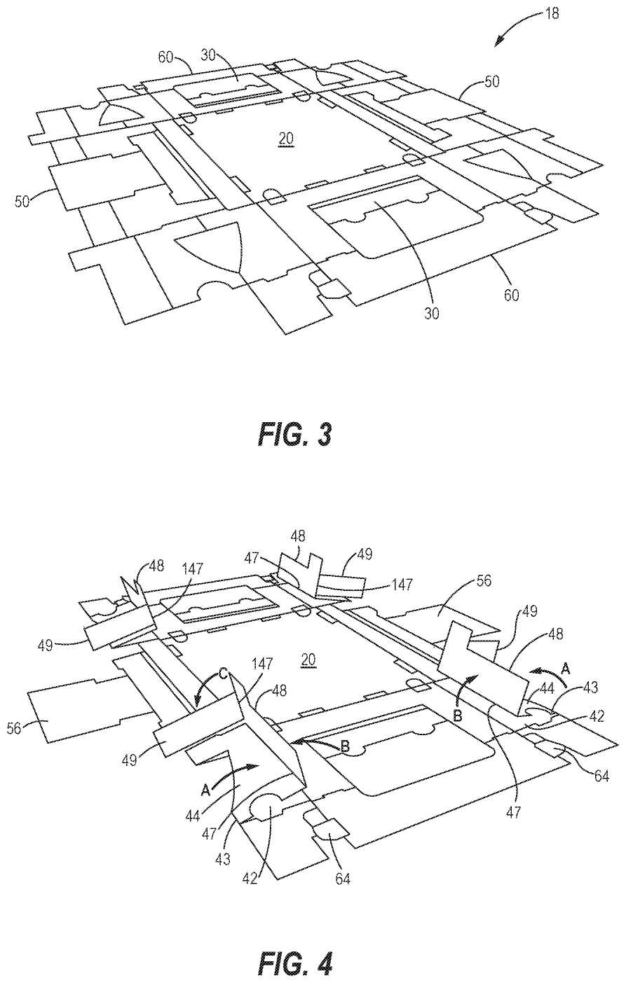

FIGS. 3-8 help illustrate how to assemble a three-dimensional shelf tray 10. As previously noted, a shelf tray 10 is made from a single shelf tray blank 18 like that shown in FIG. 3.

FIG. 4 is a perspective view of the blank 18 of FIG. 3 shown partially folded to create a partially assembled shelf tray.

In a first series of steps, each of the four end wing assemblies 40 may be assembled as follows.

The inner facing panel 44 is rotated 180 degrees along wing fold line 43 in the direction of arrow A until it is in facing, abutting relationship with its respective outer facing panel 42.

The side flap 48 is rotated outwardly 90 degrees along fold line 47 in the direction of arrow B.

The wing tab 49 is rotated outwardly 90 degrees along fold line 147 in the direction of arrow C.

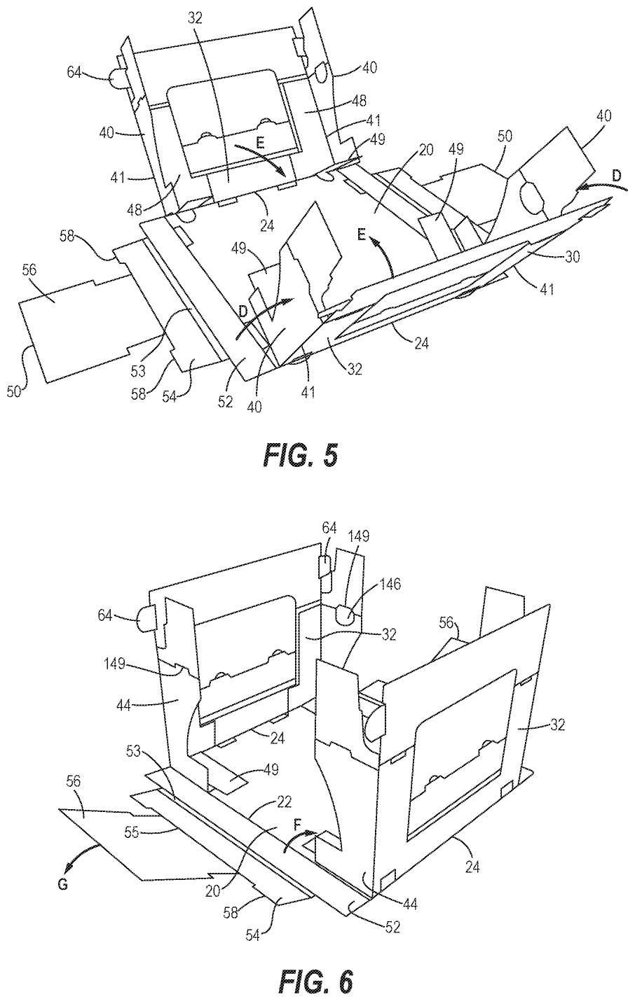

In a second series of steps depicted in FIGS. 5 and 6, each of the two side wall assemblies 30 may be assembled as follows.

Each end wing assembly 40 is rotated 90 degrees inwardly along corner fold line 41 in the direction of arrow D in FIG. 5 until it is perpendicular to the U-shaped side panel 32. After this step the side flap 48 will be in facing abutting relationship with a leg panel 36 as shown in FIG. 5.

Next, the entire side wall assembly 30 may be rotated 90 degrees along side fold line 24 in the direction of arrow E until the U-shaped side panel 32 is perpendicular to the bottom panel 20 (as shown in FIG. 6). During this step each of the two end wing assemblies 40 attached to the side wall assembly 30 along a corner fold line 41 will also rotate 90 degrees. As a result, after this step, each wing tab 49 will be in flat abutting relationship with the bottom panel 20 as shown in FIG. 6.

In a third series of steps depicted in FIGS. 6-8, each of the two end panel assemblies 50 may be assembled as follows.

The end panel assembly 50 and, more particularly, the outer end panel 52, is folded (rotated) upwardly 90 degrees along end fold line 22 in the direction of arrow F in FIG. 6 until it is perpendicular to the bottom panel 20. After this step portions of the outer end panel 52 will be in flat facing abutment with the inner facing panels 44.

The first bottom reinforcement panel 56 is rotated outwardly 90 degrees along fold line 55 in the direction of arrow G in FIG. 6.

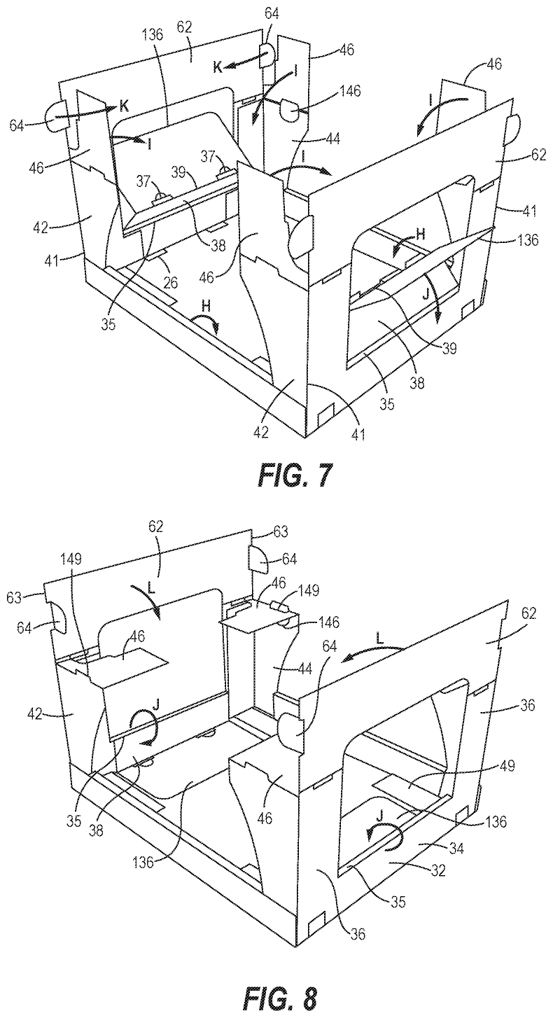

Inner end panel 54 is rotated 180 degrees inwardly along a fold line 53 in the direction of arrow H in FIG. 7 until the inner end panel 54 is in facing abutting relational with (flush against) the corresponding outer end panel 52.

End tabs 58 may be inserted into end bottom slots 28.

After this step the optional first bottom reinforcement panel 56 will be in facing abutting relationship with the bottom panel 20. Also, portions of the outer facing panel 42 and inner facing panel 44 will be captured between the outer end panel 52 and the inner end panel 54 as shown in FIG. 7.

In a fourth series of steps depicted in FIGS. 7-8, the final assembly of the shelf tray may be achieved as follows.

Each of the four top flaps 46 is rotated inwardly and downward 90 degrees along top flap fold line 148 as shown in Arrow I in FIG. 7 until it assumes the horizontal orientation (parallel to the bottom panel 20) shown in FIG. 8.

Each of the second bottom reinforcement panels 136 is rotated outwardly 90 degrees along fold line 39 as shown in Arrow J in FIG. 7.

Each of the two inner facing side panels 38 is rotated inwardly 180 degrees along double fold lines 35 until it is in flat facing abutment with the U-shaped side panel 32 as shown in FIG. 8.

Each side tab 37 may be inserted into a side bottom slot 26 to secure the inner facing side panel 38 in place.

Next, the locking tabs 64 may be folded (bent) inwardly in the direction of arrow K as shown in FIG. 7 until they assume the orientation shown in FIG. 8.

Each top ledge 62 is rotated 90 degrees downwardly along top fold line 65 in the direction of arrow L until the top ledge 62 is in a horizontal orientation, parallel to the bottom panel 20 and perpendicular to the U-shaped side panel 32. In this horizontal orientation the top ledge 62 may be in flat facing abutment with two corresponding top flaps 46.

Each locking tab 64 may be inserted into a respective slot 149 located along or adjacent to top flap fold line 148 to help secure the top ledge 62 in the horizontal orientation. The locking tab 64 then occupies the space that is notch 146 in the inner facing panel 44.

Although not preferred, in addition to the tabs and slots, glue or other adhesive may be used to assemble the shelf tray 10.

An assembled shelf tray 10 is shown in FIG. 1. On each side of the assembled shelf tray 10 the U-shaped side panel 32 and the top ledge 62 define a side window 31. Each side window 31 may be defined by (extend into) both a side 14 and the top 16 of the shelf tray 10, or the side window 31 may be wholly defined by a side 14 of the shelf tray 10. On each end 12 of the assembled shelf tray 10 the outer end panel 52 and the two outer facing panels 42 define an end opening 13. The end opening 13 communicates with a top opening 15 located between the two top ledges 62. In other words, there is no structure separating the end opening 13 and the top opening 15.

The load bearing surface may be comprise two layers of material. The bottom layer of material comprises the bottom panel 20 and the top layer of material may comprise the two first bottom reinforcement panels 56, the two second bottom reinforcement panels 136 and the four wing tabs 49. The first bottom reinforcement panels 56, the second bottom reinforcement panels 136 and the wing tabs 49 may fit together to form a continuous layer of material (one lacking any significant gaps), or there may be gaps between the structures that form the top layer of material.

The part of the shelf tray 10 that forms each corner 41 also may comprise two layers of material. The outer layer of material (facing away from the products) comprises a leg panel 36 and an outer facing panel 42 and the inner layer of material comprises a side flap 48 and an inner facing panel 44.

The resulting shelf tray 10 is a true one piece design having reinforced corners 41 to increase stacking strength and top ledges 62 to prevent shelf trays 10 from nesting into each other. The bottom 20 is reinforced with a second layer of material to allow for heavier product weights.

### Pallet Display

The top ledges 62 may be used to support one or more additional shelf trays 10. To position a second (upper) shelf tray 10 on top of a first (lower) shelf tray 10 and secure the two shelf trays together, the four bottom tabs 29 on the upper shelf tray 10 may be folded downward and inserted into top slots 33 in the lower shelf tray 10.

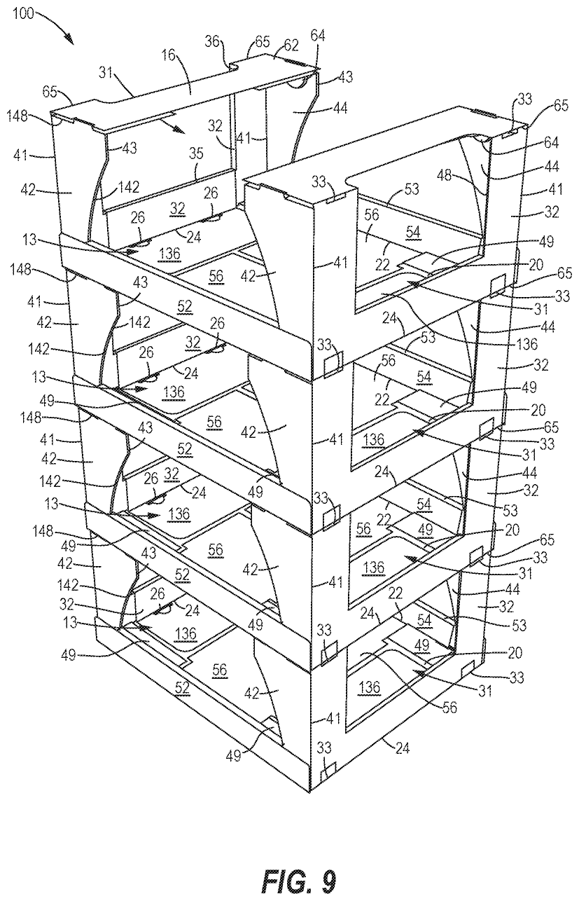

FIG. 9 is a perspective view of a pallet display 100 comprising multiple shelf trays 10. Each shelf tray 10 can be stacked on top of similar shelf trays 10 to form a multiple shelf pallet display 100 suitable for shipping and/or displaying products. The pallet display 100 may be wrapped in an outer wrap to protect the products from dust and damage during shipment, and carried on a standard pallet.

Each shelf tray 10 comprises a load bearing bottom 20, two ends 12 that may serve as the front and rear, two sides 14 and a top 16. The shelf tray 10 may be “four side shoppable”, meaning it may have openings on both ends 12 and both sides 14 for easy access to the products. The finished shelf tray 10 may be stacked on top of and secured to a second shelf tray 10 by tabs and slots or other attachment means.

### INDUSTRIAL APPLICABILITY

Two or more assembled shelf trays 10 may be part of a pallet display 100 as shown in FIG. 9. The pallet display 100 is strong enough to support the weight of the products on the shelf trays 10 and withstand the vibration and impact forces that can occur during shipping. The pallet display 100 can also withstand the weight of one or more pallet displays 8 stacked on top. The pallet display 100 is particularly suited for shipping and displaying irregularly shaped items or items that cannot withstand vertical stacking forces, such as soft-packaged products, since the shelf tray 10 can bear the entire stacking load.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

1. A shelf tray made from a single folded blank, the shelf tray configured to support one or more shelf trays stacked on top, the shelf tray comprising:
a load bearing surface for supporting one or more products, the load bearing surface comprising a bottom panel having a substantially rectangular periphery comprising two opposing end fold lines and two opposing side fold lines;
two ends, each end comprising a horizontally elongated outer end panel, two outer facing panels, each outer facing panel foldably connected to an inner facing panel along a wing fold line, the outer end panel extending upward from the bottom panel and terminating in a first fold line, each of the outer facing panels extending toward each other from respective corner fold lines and terminating in a free edge, the outer end panel and the outer facing panels defining an end opening through which the one or more products may be accessed;
two sides, each of the two sides comprising a U-shaped side panel extending upward from the bottom panel to a top fold line and laterally from one corner fold line to another corner fold line; and
a top comprising two top ledges, each of the top ledges having two top ledge ends and being hingedly attached to a corresponding U-shaped side panel along the top fold line and supported at either top ledge end by an outer facing panel, the top ledges extending toward each other from respective top fold lines.

2. The shelf tray of claim 1 further comprising:
a top flap hingedly attached to each outer facing panel along a top flap fold line; and
a locking tab foldably attached to each top ledge end; wherein
each locking tab extends through a slot located collinear with or adjacent to one of the top flap fold lines and into a notch defined by one of the inner facing panels.

3. The shelf tray of claim 2 wherein:
each notch has an inner edge that is in contact with and supports the locking tab.

4. The shelf tray of claim 1 wherein:
each of the two end openings communicates with a top opening located between the two top ledges.

5. The shelf tray of claim 1 further comprising:
an inner end panel hingedly attached to each of the outer end panels along the first fold line;
an inner facing side panel hingedly attached to each of the U-shaped side panels along a second fold line; wherein
the load bearing surface further comprises a second layer of material located on a product facing side of the bottom panel, the second layer of material comprising:
two first bottom reinforcement panels, each first bottom reinforcement panel extending inwardly from one of the inner end panels; and
two second bottom reinforcement panels, each second bottom reinforcement panel extending inwardly from one of the inner facing side panels.

6. The shelf tray of claim 5 further comprising:
a side flap hingedly attached to each of the inner facing panels along a third fold line and in flat facing abutment with one of the U-shaped side panels; wherein
the second layer of material further comprises four wing tabs, each wing tab extending from one of the side flaps.

7. The shelf tray of claim 6 wherein:
the first bottom reinforcement panels, the second bottom reinforcement panels and the wing tabs fit together to form a continuous layer of material.

8. The shelf tray of claim 1 wherein:
each of the top ledges and a corresponding U-shaped side panel define a side window through which the one or more products may be accessed.

9. The shelf tray of claim 8 wherein:
each top ledge is U-shaped; and
each side window is defined by both a side and the top of the shelf tray.

10. The shelf tray of claim 1 further comprising:
one or more bottom tabs adjacent the side fold lines and/or the end fold lines, each of the one or more bottom tabs configured to be inserted into top slots located in a second shelf tray.

11. A blank for making a shelf tray, the blank comprising:
a bottom panel having a rectangular perimeter defined by parallel, opposing side fold lines and parallel, opposing end fold lines;
two side wall assemblies, each side wall assembly hingedly attached to the bottom panel along a side fold line, each side wall assembly comprising a U-shaped side panel and an inner facing side panel, the U-shaped side panel comprising a horizontal base panel and two leg panels extending from opposite ends of the horizontal base panel, the inner facing side panel hingedly attached to the horizontal base panel along a second fold line;
four end wing assemblies, each end wing assembly comprising an outer facing panel hingedly attached to one of the leg panels along a corner fold line, an inner facing panel hingedly attached to the outer facing panel along a wing fold line, and a top flap hingedly attached to the outer facing panel along a top flap fold line, each end wing assembly defining a slot collinear with or adjacent to the top flap fold line, each inner facing panel defining a notch located along and in communication with a top edge of the inner facing panel;
two end panel assemblies, each end panel assembly comprising an outer end panel hingedly attached to the bottom panel along one of the end fold lines and an inner end panel hingedly attached to the outer end panel along a first fold line; and
two top assemblies, each top assembly comprising a top ledge having two top ledge ends and two locking tabs, each locking tab foldably attached to one of the ends, the top ledge hingedly attached to two leg panels that form one of the U-shaped side panels along a top fold line; wherein:
the blank is foldable into a three-dimensional shelf tray wherein the top ledges form a top upon which a second shelf tray may be supported, each top ledge is supported at either top ledge end by one of the outer facing panels, and each locking tab extends through one of the slots and into one of the notches.

12. The blank of claim 11 further comprising:
one or more side tabs extending from the inner facing side panel; and
one or more end tabs extending from the inner end panel; wherein
when the blank is folded into a three-dimensional shelf tray, each of the side tabs extends through a side bottom slot defined by the bottom panel and each of the end tabs extends through an end bottom slot defined by the bottom panel.
